(19) United States
(12) Patent Application Publication
(10) Pub. No.: US 2024/0362731 A1
(43) Pub. Date: Oct. 31, 2024

(54) Buildability Score

(71) Applicant: Michael J Nichols, Puyallup, WA (US)

(72) Inventor: Michael J Nichols, Puyallup, WA (US)

(21) Appl. No.: 18/140,590

(22) Filed: Apr. 27, 2023

(51) Int. Cl. G06Q 50/16

(52) U.S. Cl. CPC G06Q 50/165

(57) ABSTRACT

Techniques provide consistent and accurate estimates for the time, materials, and cost of building a house or other structure based on attributes of a lot being evaluated.

### FIELD

This invention relates generally to a buildability score for a building lot.

### BACKGROUND

When evaluating land for building a house, office, or other structure, contractors will often assess based on a gut feeling, basing their estimate on their experience, which may lead to inconsistent results.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, techniques for providing estimates of time, effort, and cost for a building project. Using input related to the characteristics of the land, including, for example, type of soil, whether utilities are on-site, slope of the land, how large the structure being built will be, and what jurisdiction the lot is in, among other factors.

It may use this input to estimate time and cost of building on the land. This estimate may be helpful for homeowners, builders, and real estate professionals who need to know the potential cost of building on a particular piece of land. People may use this information to select a lot to develop or purchase. They may also use the information to decide if they should improve or maintain ownership of a lot,

Many of the attendant features may be more readily appreciated as they become better understood by reference to the following detailed description considered in connection with the attached drawings.

### BRIEF DESCRIPTION OF THE DRAWINGS

FIG. 1 illustrates a side view of a lot of land.

FIG. 2 illustrates an overhead view of a lot of land.

FIG. 3 shows a sample of attributes supporting a buildability score.

### DETAILED DESCRIPTION

Like reference numerals are used to designate like parts in the accompanying drawings.

A Buildability Score may be a numeric value determined by a point system based on various attributes applied to a property. When providing an estimated cost of building a house, for example, attributes may be considered, including, for example, whether there are wetlands on the property, what the soil type is, the lot size, whether there are utilities on site, whether septic is needed, how large the structure being built is, whether it is being built on water, whether the land has a slope greater than 15 degrees, what entity has jurisdiction for the lot, a city or county, what type of ground cover there is (for example, is it forested or covered lightly by brush?), will a well be required, are outbuildings being built, are there structures or other items on the property that need to be demolished or removed, when the client wishes to start, whether the client has built a house before, does the client own the property, whether home plans have been purchased, whether a construction loan has been pre-approved, what the client is intending to build (for example, single family or multi-family), whether there will be impact fees assessed, and whether this will be a primary home or an investment property.

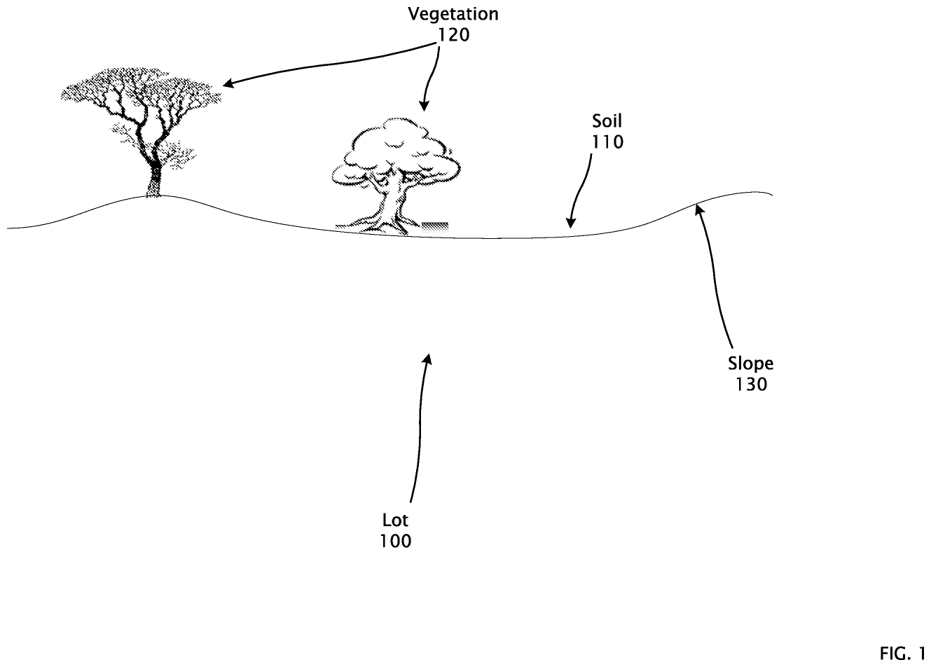

FIG. 1 illustrates a side view of Lot 100. Lot 100 may have Soil 110 of gravel, and Vegetation 120 may be considered lightly forested. Slope 130 may be 10 degrees. These values and other attributes of Lot 100 may be used to calculate a Buildability Score.

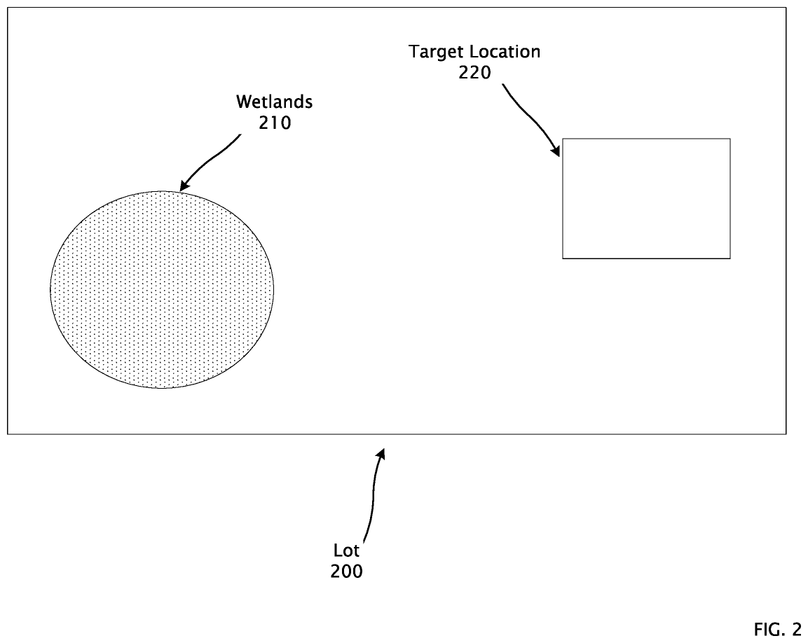

FIG. 2 illustrates an overhead view of Lot 200. Lot 200 may have Wetlands 210 near one corner, with a plan to build a structure at Target Location 220 near a side of Lot 200 away from Wetlands 210.

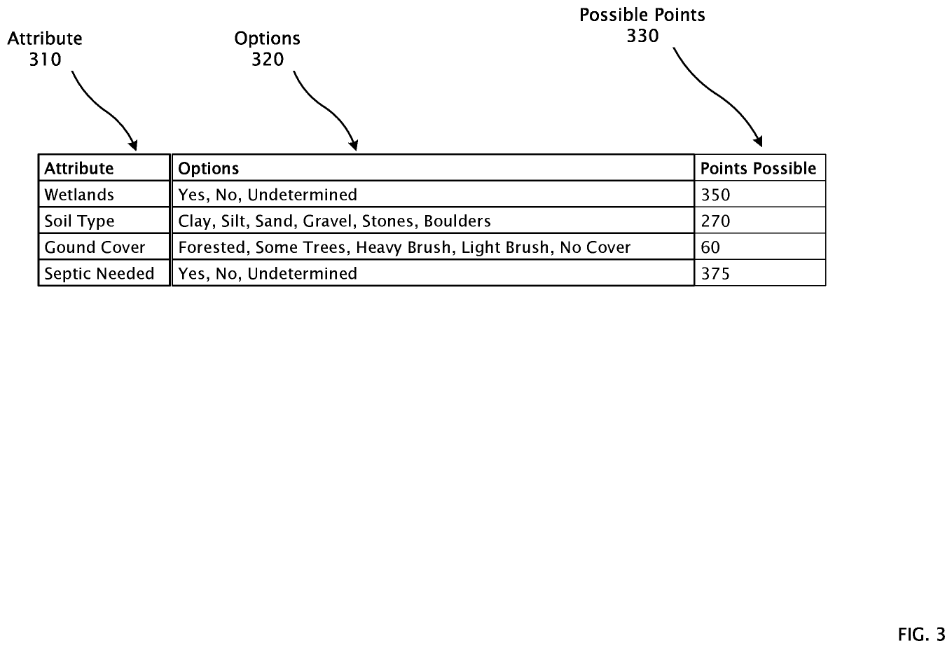

FIG. 3 shows a sample of Attributes 310 supporting a buildability score. Attribute 310 may be an attribute of a property that may affect the cost or time to build one or more structures on the property. For example, Options 320 for Soil Type may be Clay, Silt, Sand, Gravel, stones, or boulders. Various Possible Points 330 may be assigned depending on the soil type, and that score may be incorporated when determining a Buildability Score.

Examples of attributes and related points are shown in the following table:

TABLE 1

| Attribute | Options | Points |
|---|---|---|
| Wetlands | Yes | 350 |
| | No | 0 |
| | Undermined | 125 |
| Soil Type | Clay | 270 |
| | Silt | 170 |
| | Sand | 50 |
| | Gravel | 50 |
| | Stones | 170 |
| | Boulders | 270 |
| Lot Size | <0.20 | 215 |
| | >0.20-0.30 | 40 |
| | >0.30-0.40 | 50 |
| | >0.40-0.50 | 40 |
| | >0.50 | 50 |
| Utilities On Site | Yes | 0 |
| | No | 90 |
| | Nearby | 50 |
| | Undetermined | 70 |
| Septic Needed | Yes | 375 |
| | No | 0 |
| | Undetermined | 200 |
| Home Sq Ft | <2000 | 30 |
| | >2000-3000 | 60 |
| | >3000-4000 | 90 |
| | >4000-5000 | 120 |
| | >5000 | 150 |
| Building on Water | Yes | 600 |
| | No | 0 |
| Building on Slope >15 degrees | Yes | 400 |
| | No | 0 |
| | Undetermined | 250 |
| Lot Jurisdiction | City | 90 |
| | County | 0 |
| Ground Cover | Heavily Forested | 60 |
| | Some Trees | 45 |
| | Heavy Brush | 30 |
| | Light Brush | 20 |
| | No Cover | 0 |

In addition, other factors may be considered, including:

| | | |
|---|---|---|
| Attribute | Options | Points |

| | |
|---|---|
| Is a well required for water? | Yes |
| | No |
| | Undetermined |
| Are you building outbuildings? | Yes |
| | No |
| | Undetermined |
| Is demolition or removal required? | Yes |
| | No |
| | Undetermined |
| How soon do you want to start? | Immediately |

| | |
|---|---|
| 1-2 | months |
| 2-6 | months |
| >6 | months |

| | |
|---|---|
| Have you ever built a home? | Yes |
| | No |
| Do you own the property? | Yes |
| | No |

| Attribute | Options |
|---|---|
| Have you purchased home plans? | Yes |
| | No |
| Have you been pre-qualified for a | Yes |
| construction loan? | No |
| What do you plan to build? | Single Family Home |
| | Detached additional dwelling |
| | Attached Additional Dwelling |
| | Multi-Family |
| Will you have any impact fees? | Yes |
| | No |
| | Undetermined |
| Will this be your home or investment? | My Home |
| | Investment Property |

While points are shown for various attributes, variations may be made for particular cases. For example, if the soil type is boulders, there may be some variation in points in cases where the boulders are exceptionally large. That may result in a larger number of points than the standard 270 points.

The total points may be added together to determine a Buildability Score, which may allow, for example, a client or a builder to evaluate which lot to build on if multiple lots are being considered. A lower score is better

For example, if a property has the following attributes:
Wetlands: Yes (350 points);
Soil Type: Clay (270 points);
Lot Size: 5 acres (50 points);
Utilities On Site: No (90 points);
Septic Needed: Yes (375 points);
Home Sq. Ft.: 2000 (30 points);
Building on Water: No (0 points);
Building on Slope>15 degrees: No (0 points);
Lot Jurisdiction: County (0 points);
Ground Cover: Some Trees (45);
This property may have a Buildability Score of 1210.
If another property has the following attributes: Wetlands: No (0 points);
Soil Type: Clay (270 points);
Lot Size: 0.4 acres (40 points);
Utilities On Site: No (90 points);
Septic Needed: Yes (375 points);
Home Sq. Ft.: 2000 (30 points);
Building on Water: No (0 points);
Building on Slope>15 degrees: No (0 points);
Lot Jurisdiction: County (0 points);
Ground Cover: Some Trees (45);
it may have a buildability score of 850. This information may indicate a lower cost for developing the property.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A method for selecting which lot of land to develop or purchase, comprising:
assigning a first value for each of a first set of attributes of a first lot of land, the set of attributes including whether there are wetlands, a soil type, lot size, whether there are utilities on site, whether a septic system is needed, a planned size of a house, whether there will be building on water, whether there will be building on a slope, whether the lot is in a jurisdiction of a city or count, and what ground cover is on the lot;
adding the assigned first values of the first set of attributes, giving a first buildability score;
assigning a second value for each of a second set of attributes of a second lot of land, the set of attributes including whether there are wetlands, a soil type, lot size, whether there are utilities on site, whether a septic system is needed, a planned size of a house, whether there will be building on water, whether there will be building on a slope, whether the lot is in a jurisdiction of a city or count, and what ground cover is on the lot;
adding the assigned second values of the second set of attributes, giving a second buildability score; and
selecting the lot associated with the first buildability score or the second buildability score, whichever is lower.

2. A method for selecting whether to improve or maintain ownership of a lot of land, comprising:
selecting a threshold value for a first buildability score;
assigning a value for each of a set of attributes of a lot of land, the set of attributes including whether there are wetlands, a soil type, lot size, whether there are utilities on site, whether a septic system is needed, a planned size of a house, whether there will be building on water, whether there will be building on a slope, whether the lot is in a jurisdiction of a city or count, and what ground cover is on the lot;
adding the assigned values of the set of attributes, giving a second buildability score; and
improving or maintaining ownership of the lot if the first buildability score is lower than the second buildability score.
